(19) United States
(12) Patent Application Publication
(10) Pub. No.: US 2010/0049658 A1
(43) Pub. Date: Feb. 25, 2010

(54) SECURE ELECTRONIC TRANSACTION SYSTEM

(76) Inventors: Javier Sanchez, Miami, FL (US); Tai-Kei Cheung, Kowloon (HK); Gary Sweeney, Scottsdale, AZ (US); Arthur Scott Gilbert, Scottsdale, AZ (US); John Waycott, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/197,117

(22) Filed: Aug. 22, 2008

(51) Int. Cl. H04L 9/00

(52) U.S. Cl. 705/64

(57) ABSTRACT

Systems and methods for the secure processing of electronic transactions are disclosed. In accordance with an exemplary embodiment, a system and method for the secure processing of electronic transactions comprises: receiving, by a POS terminal, information for a financial transaction card; receiving, by the POS terminal, information for a financial transaction; encrypting, by the POS terminal, the financial card information and the financial transaction information into a first encrypted message; transmitting the first encrypted message to a regional chassis; encrypting, by the regional chassis, the first encrypted message into a second encrypted message; transmitting the second encrypted message to a central chassis; decrypting, by the central chassis, the second encrypted message into a decrypted message; and transmitting the decrypted message to a host processor for authorization.

### CROSS-REFERENCE TO RELATED APPLICATIONS

This application claims priority to and benefit of U.S. Provisional Application No. 60/775,745, entitled “Secure Electronic Transaction System” filed on Feb. 22, 2006, and PCT Application No. PCT/US2007/062603, filed Feb. 22, 2007, all incorporated herein by reference.

### FIELD OF INVENTION

The present invention relates generally to electronic transaction systems, and in particular to secure electronic transaction systems that are protected against attacks and data interception by third parties.

### BACKGROUND OF THE INVENTION

Fraud sophistication has rapidly increased, escalating from a single point of collection to the concentration site. Skills increase from using a small common device, such as personal digital assistants (PDAs) and readers, for one-at-a-time card skimming to, in the Malaysian news, where crooks manage to integrate a testing instrument and a personal computer (PC), into a data collection device. This was a clever addition to the arsenal of tools used to attack the credit card system.

Industry regulations, such as those put forth through EMV standards, are helping to slow the epidemic; however, they are beginning to drive fraud further away from the traditional point of purchase. Now, fraud has been driven into the “nerve center” of the advanced transaction framework and into the network itself.

Recent world reports of “wiretapping” fraud is a topic of concern throughout the payment industry. Wire, or line tapping involves the illegal installation of a monitor on the merchant's phone line, and systematic extraction of credit and debit card data from the terminal's data traffic.

In the current transaction transport architecture, point-of-sale (POS) transactions are sent in the clear, making it possible for technically savvy criminals to quickly intercept sensitive information by grabbing data in the middle of the transaction transport, a ‘man-in-the-middle’ attack.

This new dimension of “cyber-theft” has accelerated the need for a sophisticated encryption capability for POS transaction traffic. The challenge is to create an encryption system that is secure to any commercially viable attack, but is simple enough to apply to existing networks with a minimal operational or administrative overhead.

### BRIEF DESCRIPTION OF THE DRAWINGS

A more complete understanding of the present invention may be derived by referring to the detailed description and claims when considered in connection with the drawing Figures, where like reference numbers refer to similar elements throughout the Figures, and:

FIG. 1 illustrates an exemplary secure electronic transaction system in accordance with an embodiment of the present invention;

FIG. 2 is a flow diagram illustrating an exemplary process for secure processing of an electronic transaction; and

FIG. 3 illustrates the construction of an electronically secure transaction message in accordance with an embodiment of the present invention.

### DETAILED DESCRIPTION OF THE INVENTION

The present invention may be described herein in terms of various components and processing steps. It should be appreciated that such components and steps may be realized by any number of hardware and software components configured to perform the specified functions. For example, the present invention may employ various electronic control devices, visual display devices, input terminals and the like, which may carry out a variety of functions under the control of one or more control systems, microprocessors or other control devices. In addition, the present invention may be practiced in any number of electronic transaction contexts and the exemplary embodiments relating to a system and method for the secure processing of electronic transactions are merely a few of the exemplary applications for the invention. For example, the principles, features and methods discussed may be applied to any electronic transaction application.

For the sake of brevity, conventional electronic transaction processing, data networking, application development, and other functional aspects of the systems (and components of the individual operating components of the systems) may not be described in detail herein. Furthermore, the connecting lines shown in the various figures contained herein are intended to represent exemplary functional relationships and/or physical connections between the various elements. It should be noted that many alternative and/or additional functional relationships or physical connections may be present in a practical system.

In accordance with an embodiment of the present invention, a secure electronic transaction system provides for the following features:

All or a portion of the transaction data passed between a POS terminal and an access network is encrypted so that it is rendered secure from any commercially viable attack. However, the ‘strength’ of the encryption system is commensurate with the processing and memory capabilities of the range of POS terminals, including ‘legacy’ models that may not contain ‘hardware acceleration’ for encryption.

The ‘keys’ used by the encryption system are under the control of the operator of the POS network or the owners of the terminals.

The system supports the concept of multiple keys, so that different acquirers, processors and/or terminal vendors can opt to have their own, unique keys if they so wish.

Several options are available for the loading of keys into the POS terminals, depending on the relative security or logistics needs of the customers. These options range from a highly secure scheme that employs ‘injecting’ debit-PIN keys, to a simple, in-the-field, automated download of keys from the network to the terminal.

The implementation of the secure electronic transaction system is straight-forward in design in order to minimize the development effort that is required and to allow a fast time to market.

As will be described, the present invention provides for a secure electronic transaction system with a unique internal and external transport protection mechanism, using encryption technology that can safely transport POS terminal data while preventing any data interception by outside parties.

In accordance with an embodiment of the present invention, a secure electronic transaction system will be described that allows all or a portion of the transaction data passed between a POS terminal and an access network to be encrypted so that it is rendered secure from any commercially viable attack. Being sensitive to the existing terminal population, secure electronic transaction system is backward compatible with the processing and memory capabilities of a whole range of POS terminals—including legacy models that may not contain hardware acceleration for encryption.

As used herein, “EDS” refers to Encryption Definition Section.

“KEK” refers to Key Encryption Key, which is a key that is used to encrypt another key.

“KIN” refers to Key Index Number. This is a number set by the acquirer for a population of terminals. The KIN allows each terminal population to have their own transaction key.

“NAC” refers to Network Access Controller. In accordance with an embodiment of the present invention, the functions of the NAC are performed by the software running on the port processors as described below.

“PED” refers to a personal information number (PIN) Encryption Device and may be a device or a terminal with a built-in secure PIN pad.

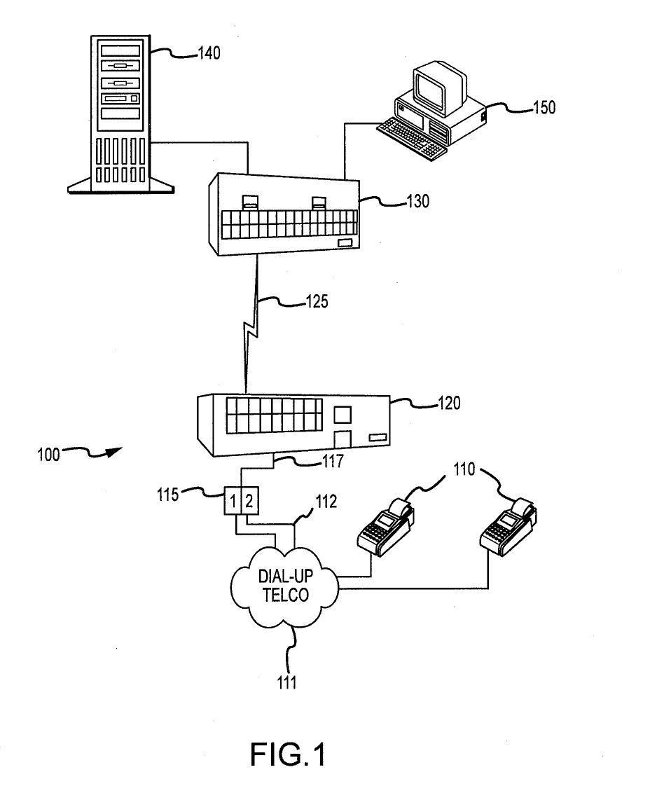

FIG. 1 illustrates a secure electronic transaction system 100 in accordance with an embodiment of the present invention. System 100 comprises one or more POS terminals 110, cables 112 and 117, port processor 115, regional chassis 120, network 125, central chassis 130, and host 140.

POS terminals 110 may be any conventional POS terminals that are used for electronic transactions. For example, POS terminals 110 may comprise T7 Plus terminals that are available from Hypercom corporation.

POS terminals 110 may be connected, via a conventional telephone network or Internet 111 to regional chassis 120. Cables 112 and 117 and port processor 115 may be used to connect regional chassis 120 to network 111 such that chassis 120 can communicate with POS terminals 110. Port processor 115 may comprise a processor such as the CID 63 processor available from Hypercom Corporation. The port processor may include an encryption module for performing encryption of data. Cable 117 may comprise a T63 cable available from Hypercom Corporation. POS terminals 110 may include software modules that provide for the encryption of information.

Regional chassis 120 is connected to central chassis 130 by network 125, such as a frame relay network or an Ethernet connection. Port processor 115 may be used by regional chassis 120 to communicate with central chassis 130 over network 125. Central chassis may also include a port processor (not illustrated) for performing communication and encryption functions. Central chassis 130 communicates with host 140. Host 140 provides for authorization of the electronic transaction. Optionally, computer 150 may be used for remote configuration of central chassis 130 and as a network management system.

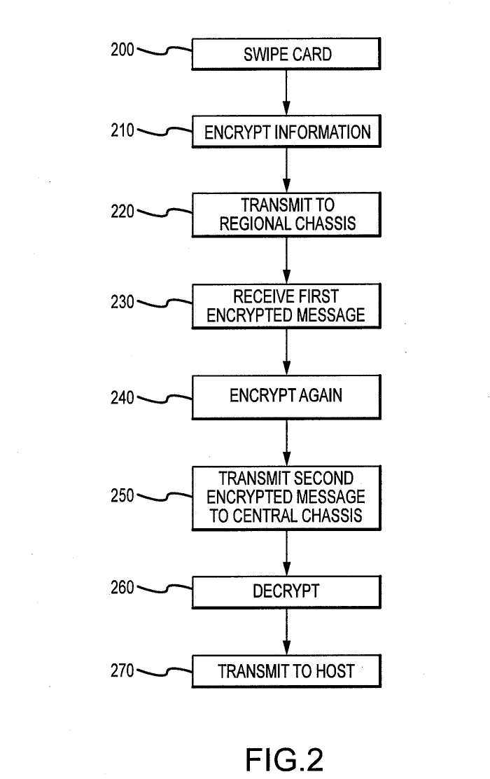

With reference to FIG. 2, the operation of system 100 will be now be described. An electronic transaction is initiated at POS terminal 110. A user swipes a financial transaction card (i.e., credit card, debit card, smart card) (step 200) at POS terminal 110 or otherwise enters information about a consumer's financial transaction card. Other transaction information, such as the transaction amount, may also be entered into POS terminal 110. The POS terminal encrypts some or all of the financial card information and the transaction information (step 210) and transmits the information to regional chassis 120 (step 220) via port processor 115. Thus, a fully encrypted message may be provided for from the POS device to the regional network.

Regional chassis 120 receives the encrypted message from POS terminal 110 via port processor 115 (step 230). Regional chassis 120 again encrypts the message (step 240) and transmits the message (step 250) over the Ethernet or frame relay 125 to central chassis 130. Central chassis 130 decrypts the message (step 260) and the decrypted message is transmitted (step 270) to host 140 for authorization. Once the authorization is complete, the process reverses itself back to POS terminal 110.

The network encryption support of the present invention can be extended to the POS terminal by adding Triple-DES hardware and software module to actually deployed in-coming port processors.

On the terminal side, the software module integrates into the end-user's software and can be deployed in conjunction with the next terminal software upgrade.

The secure electronic transaction system creates an intelligent encryption method from the source device (POS, ATM) to a local secure access point of the transport environment. By encrypting this “last-mile” portion/leg there is no need for long and costly host modifications, creating a reasonable (tamper-resistant) secure communication over the uncontrollable environment of dial lines.

Although messages can be deliver encrypted to the host, concentrating the de/encryption task over to the centralized peripheral devices could create bottlenecks, considering that the actual job for this security boxes is based on a 4/6 byte PIN-Block, a full message process, up to 200 bytes, which could collapse the system.

The secure electronic transaction system secures the transaction while isolating the central system from the costly de-encryption task.

In accordance with an embodiment of the present invention, secure electronic transaction system 100 supports the following features:

NACs are backward compatible with the existing terminal population.

System 100 contributes very little additional overhead to transaction times.

All, part or none of a message from POS terminal 110 can be encrypted.

System 100 uses data encryption standard (DES) or Triple-DES algorithms. Keys are not exchanged.

The acquirers or processors manage their own keys. Each acquirer or processor can have their own set of up to 4095 unique keys.

Support standards include encryption Algorithms for DES CBC-64, Triple-DES CBC-64 dual key, and ISO 8583 message format.

In accordance with an aspect of the present invention, each network may have its own set of keys, controlled by a network management system, and the key injection system for POS terminal 110. A Key Index Number (KIN) uniquely identifies each key within the network. In accordance with one embodiment of the present invention, the KIN can be any value from 1 to 4095.

In accordance with one embodiment of the present invention, the DES key may be eight bytes in length and the Triple DES dual key may be 24 bytes in length using two eight-byte keys. The two keys may be concatenated together to create a 24-byte using the equation K1∥K2∥K1, where the II symbol means concatenation.

A terminal PED is injected with a key and a KIN for each NII that supports encryption. The acquirer will determine the actual keys used. The acquirer uses their facilities and procedures to inject the keys into the terminal. System 100 does not require a particular process for how keys are injected into the terminals, nor how this information is retained within the terminal or PED.

In accordance with an embodiment of the present invention, terminal 110 sends the KIN along with the encrypted transaction. The NAC looks up the KIN in its key table to find the key and decrypts the message before passing it to the host processor. The return message is always sent in the clear to the terminal.

For the NAC to distinguish between encrypted and non-encrypted transactions, a TPDU ID hexadecimal 70 may be used to identify an electronic secure transaction in accordance with the present invention. Immediately following the TPDU is the Encryption Definition Section (EDS) that defines encrypted portion of the message. This is followed by the ISO 8583 transaction in which some or all of the data may be encrypted. When a NAC receives an electronically secure transaction, it decrypts the message, removes the EDS and changes the TPDU to a standard hexadecimal 60 TPDU.

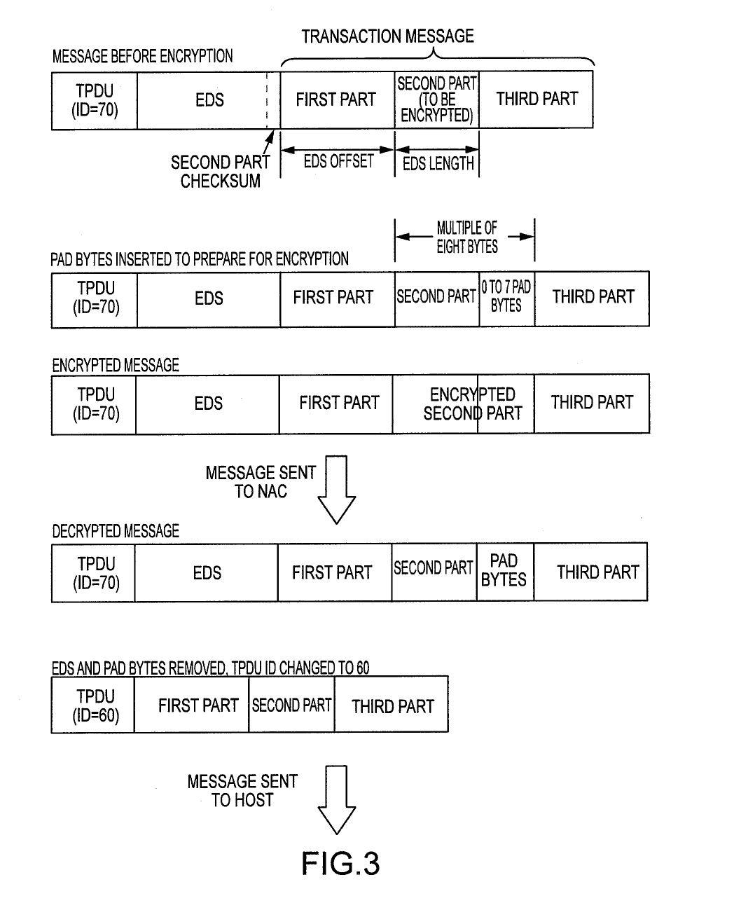

With reference to FIG. 3, the construction of an electronically secure transaction message format is illustrated in accordance with an embodiment of the present invention.

When POS terminal 110 connects to an acquirer with a non-zero KIN, it will encrypt the message using the associated key and send the KIN with the EDS and extended TPDU. In accordance with an embodiment of the present invention, the CBC-64 mode (cipher feedback 64-bit) DES and Triple DES algorithms are supported.

The terminal fills in the EDS with the following information:
The length of the encrypted data
The starting offset of the encrypted data within the message
Checksum of the data before encryption
The KIN for the acquirer.

The TPDU ID is set to 0x70 and the message is sent to the NAC.

The NAC has three possible responses:

Host Response—the host receives the transaction, processes it and sends a response. The transaction response is processed normally.

Invalid Key—the computed checksum does not match the checksum in the EDS.

Network Error—other network errors are handled in the same fashion as they are with other messages.

HVZ Log Record. The HVZ and POS applications emit transaction-logging records when a transaction completes or fails. The EDS portion of a message is not sent in the logging record.

Header Format. In accordance with an embodiment of the present invention, TPDU message format is described below. The number of bits in each field is shown in the header as a subscript.

| TPDU | | | EDS | | | | |
|---|---|---|---|---|---|---|---|
| TPDU ID₈ = 0x70 | NII₁₆ | SRC₁₆ | Control₄ | KIN₁₂ | Start₁₆ | Length₁₆ | Checksum₈ |

The Encryption Definition Section (EDS) follows the TPDU. Each field is defined below:

| | |
|---|---|
| TPDU ID | TPDU Identifier. A single byte that describes the type of TPDU. 0x70 |
| | and 0x78 indicate the presence of the EDS. The EFTSec TPDU IDs |
| | 0x70 and 0x78 correspond to the standard TPDU IDs 0x60 and 0x68 |
| | respectively. |
| NII | NII Field of TPDU |
| SRC | Source Address Field of TPDU |
| Control | Control nibble. These four bits are reserved for future use and must be |
| | zero for the current version of the EFTSec message format. |
| KIN | The KIN is the Key Index Number. KINs range from 1-4095. KIN = |
| | zero represents an unencrypted message. |
| Start | The starting offset of the encrypted portion of the message, in big-endian |
| | format. The offset zero represents the byte immediately following the |
| | EDS. |
| Length | Length is the length of the encrypted portion of the message. The 64-bit |
| | cipher feedback mode (CBC-64) of DES and Triple DES are supported. |
| | CBC-64 requires a multiple of eight bytes of data to encrypt and decrypt. |
| | If the length of data is not a multiple of eight bytes, the terminal must |
| | append pad bytes after the data that is going to be encrypted. Zero to |
| | seven bytes should be appended, to bring the total number of bytes to a |
| | multiple of eight. The Length field in the EDS should always represent |
| | the actual number of bytes in the message; it should not include the |
| | length of the pad bytes. |
| Checksum | Checksum of the encrypted portion of the data. The checksum is |
| | calculated on the clear text (before encryption) and is the eight-bit sum |
| | of each byte beginning with the start byte and continuing through the length. |
| | A checksum of 0x00 indicates that the terminal did not calculate a |
| | checksum and the NAC would not perform verification. |
| | If the computed checksum is 0x00, the NAC will not verify it and send |
| | the message up to the host. |

Checksum Algorithm

The following example C code calculates the checksum in the EDS. The routine assumes that the message contains a valid TPDU, EDS and data in consecutive bytes in memory, with message pointing to the start of the TPDU.

| #define START 7 | /* position of start word */ |
|---|---|
| #define LENGTH 10 | /* position of length word */ |
| #define HEADERLEN 12 | /* length of TPDU and EDS */ |
| unsigned char Calculate_{—} checksum(unsigned char *message) | |
| { | |
| unsigned int start; | /* start value from the EDS */ |
| unsigned int length; | /* length value from the EDS */ |
| unsigned char checksum; | /* calculated checksum */ |

```
    start = (message[START]<< 8) + message [START+1];
    length = (message[LENGTH] << 8) + message[LENGTH+1];
    offset = start + HEADERLEN;
    checksum = 0;
    while (length−−)
    {
        checksum += message[offset++];
    }
    return checksum;
}
```

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described exemplary embodiments that are known to those of ordinary skill in the art are expressly incorporated herein by reference and are intended to be encompassed by the present claims.

We claim:

1. A method for electronically processing transactions, comprising:
a) receiving, by a point-of-sale (POS) terminal, information for a financial transaction card;
b) receiving, by the POS terminal, information for a financial transaction;
c) encrypting, by the POS terminal, the financial card information and the financial transaction information into a first encrypted message;
d) transmitting the first encrypted message to a regional chassis;
e) encrypting, by the regional chassis, the first encrypted message into a second encrypted message;
f) transmitting the second encrypted message to a central chassis;
g) decrypting, by the central chassis, the second encrypted message into a decrypted message; and
h) transmitting the decrypted message to a host processor for authorization.

2. The method of claim 1, further comprising:
selecting a key from a plurality of keys for use in encrypting the financial card information and the financial transaction information; and
loading the selected key into the POS terminal.

3. A secure electronic transaction system, comprising:
a point-of-sale (POS) terminal;
a regional chassis, wherein the POS terminal is connected via a communication link to the regional chassis, wherein the regional chassis is configured to receive financial transaction information from the POS terminal and the regional chassis is further configured to encrypt the received financial transaction information; and
a central chassis, wherein the regional chassis is connected to the central chassis by a network, wherein the central chassis is configured to receive encrypted financial transaction information from the regional chassis and the central chassis is further configured to decrypt the received financial transaction information prior to sending the financial transaction information to a host processor.

4. The secure electronic transaction system of claim 3, wherein the POS terminal is configured to encrypt the financial transaction information prior to sending the information to the regional chassis.

5. The secure electronic transaction system of claim 4, wherein the POS terminal is configured to encrypt the financial transaction information using a key selected from a plurality of encryption keys.
